(19) United States
(12) Patent Application Publication
(10) Pub. No.: US 2019/0303658 A1
(43) Pub. Date: Oct. 3, 2019

(54) MOTION GENERATING APPARATUS, MODEL GENERATING APPARATUS AND MOTION GENERATING METHOD

(71) Applicant: Preferred Networks, Inc., Chiyoda-ku (JP)

(72) Inventors: Takahiro ANDO, Chiyoda-ku (JP); Shimpei SAWADA, Chiyoda-ku (JP); Toru MATSUOKA, Chiyoda-ku (JP)

(73) Assignee: Preferred Networks, Inc., Chiyoda-ku (JP)

(21) Appl. No.: 16/368,367

(22) Filed: Mar. 28, 2019

(30) Foreign Application Priority Data
Mar. 29, 2018 (JP) 2018-064633

(51) Int. Cl. G06K 9/00; G06N 3/08; G06T 13/40

(52) U.S. Cl. CPC G06K 9/00348; G06T 13/40; G06N 3/08; G06K 9/00369

(57) ABSTRACT

A motion generating apparatus includes memory and processing circuitry coupled to the memory. The memory is configured to store a learned model. The learned model outputs, when path information is input, motion information of an object which moves according to the path information. The processing circuitry accepts input of parameters regarding a plurality of objects, and generates path information of the plurality of objects based on the parameters according to predetermined rules. The processing circuitry inputs the generated path information of the plurality of objects into the learned model, and causes the learned model to generate motion information with respect to the path information of the plurality of objects.

### CROSS-REFERENCE TO RELATED APPLICATIONS

This application claims the benefit of and priority to Japanese Patent Application No. 2018-064633, filed on Mar. 29, 2018, the entire contents of which are incorporated herein by reference.

### FIELD

The embodiments described herein relate to a motion generating apparatus, a model generating apparatus, a motion generating method and a non-transitory computer-readable medium.

### BACKGROUND

In making movies, animations, games, and the like, video images where many humans or animals simultaneously make motions are sometimes used. For example, when such video images are generated by using CG (computer graphics) or the like, it costs a lot in order that each object can move naturally. A method is therefore widely studied to generate such video images by using arithmetic operations of a computer.

A motion generation method using a rule-based artificial intelligence (AI) is widely used, but in this method, it is often the case that already photographed motions are reproduced, and variation in motions of each object was limited. For example, the motion of each individual was generated according to the small number of determined patterns which are input in advance, and there was a lack of a delicate motion change in response to a situation (for example, a minute motion of a joint, or the like). The motion generation by using a neural network is also possible, but it has been difficult to deal with situations such as avoiding or colliding with each other as for a plurality of objects, and as a result, it was difficult to deal with a crowd.

### BRIEF DESCRIPTION OF THE DRAWINGS

FIG. 1 illustrates an example of functions of a motion generating apparatus according to some embodiments;

FIG. 2A to FIG. 2C each illustrates an example of path information according to some embodiments;

FIG. 3 illustrates an example of motion information according to some embodiments;

FIG. 4 illustrates processing of the motion generating apparatus according to some embodiments;

FIG. 5 and FIG. 6 each illustrates an example of GUI of a parameter input acceptor according to some embodiments;

FIG. 7 illustrates an example of functions of a model generating apparatus according to some embodiments; and

FIG. 8 illustrates a hardware implementation example according to some embodiments.

### DETAILED DESCRIPTION

Daniel Holden, et.al, “Phase-functional neural networks for character control,” Journal of ACM Transactions on Graphics (TOG), volume 36, Issue 4, July 2017, Article No. 42, is hereby incorporated by reference in their entirely.

According to some embodiments, a motion generating apparatus may include a memory configured to store data, and processing circuitry coupled to the memory, the processing circuitry being configured to accept input of parameters regarding a plurality of objects, generate path information of the plurality of objects based on the parameters according to predetermined rules, store a learned model which outputs motion information of an object which moves according to path information when the path information is input, to the memory, and input the generated path information of the plurality of objects into the learned model, and generate motion information with respect to the path information of the plurality of objects. Here, the term “processing circuitry” refers to “FPGA, CPU, GPU or other processing devices implemented on electronic circuits.

Embodiments will now be explained with reference to the accompanying drawings. In the following explanation, video images may be output, where video images in a broad sense are indicated such as pure CG video images such as real video images, animation video images, games, and still images. An object to be a target for which motions are generated is explained as a virtual human, but the object is not limited thereto, and it may be anyone or anything as long as it is an object which moves with a will of its own such as an animal and an automobile.

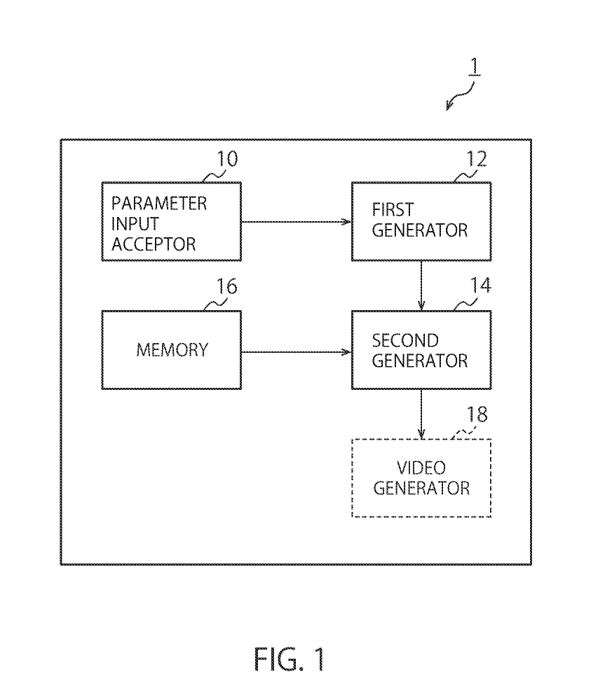

FIG. 1 is a block diagram illustrating functions of a motion generating apparatus according to some embodiments. A motion generating apparatus 1 includes a parameter input acceptor 10, a first generator 12, a second generator 14, a memory 16, and a video generator 18. The motion generating apparatus 1 may output an appearance where a crowd moves (hereinafter, it is described as a crowd motion) in accordance with parameters when, a user, for example, an artist generating video images issues parameters.

The parameter input acceptor 10 may be an interface (e.g., a user interface) for the user to input parameters. The user may input scene information and object information to the motion generating apparatus 1 through the parameter input acceptor 10. The object information may be information such as, for example, gender, age, a body height, a body weight, a moving speed at a normal time, and so on of an object. The number of persons, an allocation area, and so on of the object may be also included. The object information may be set such that values thereof or the like are moderately dispersed by using a random number.

The scene information is a generic name of allocation information of the object, and information of environment or the like which affects the object. The scene information may contain, for example, information of buildings, obstacles, and the like being a range where the object is movable, or information of a range where buildings, obstacles, and the like are not contained. The scene information may be two-dimensional information, or three-dimensional information. Besides, the scene information may be change information along a time series such that an element which affects the object is allocated at a predetermined position after a predetermined time, or the like such as, for example, information that a disaster like a fire disaster occurs at a certain time, at a certain position, as the information of environment or the like which affects the object in addition to the information of the buildings or the like. Such information may be input as the parameters from the parameter input acceptor 10.

The first generator 12 may generate and output path information regarding movements of a plurality of objects based on the parameters which are specified by the user and accepted by the parameter input acceptor 10. The path information may be information representing a position, speed, acceleration, an event, and so on at each time by a scalar, a vector, a character string, or the like at a path of each object (hereinafter, it is described as a path). The event means, for example, an element which affects the object at a certain time.

This first generator 12 may generate the path information through a rule-based method where output data are generated from input data based on, for example, predetermined rules. In the rule-based method, the path information of each object may be generated based on the rule defined in advance in a range where the object is movable. Examples of the rule-based method include the rule-based AI where the output data is generated from the input data based on the predetermined rules, other procedural processing, but the rule-based method is not limited thereto, and a rule-based multi-agent system is also included.

The generated path information may be output to the second generator 14, but parameters such as age and gender which can be used for motion generation may be output together with the path information.

In some embodiments, the memory 16 may be implemented with EPROM, EEPROM, SDRAM, and flash memory devices, CD ROM, DVD-ROM, or Blu-Ray® discs and the like. In some embodiments, at least one or more of the parameter input acceptor 10, the first generator 12, the second generator 14, and the video generator 18 may be implemented with a circuit (e.g., circuitry of a FPGA, CPU, GPU or other processing circuits implemented using electronic circuits), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like.

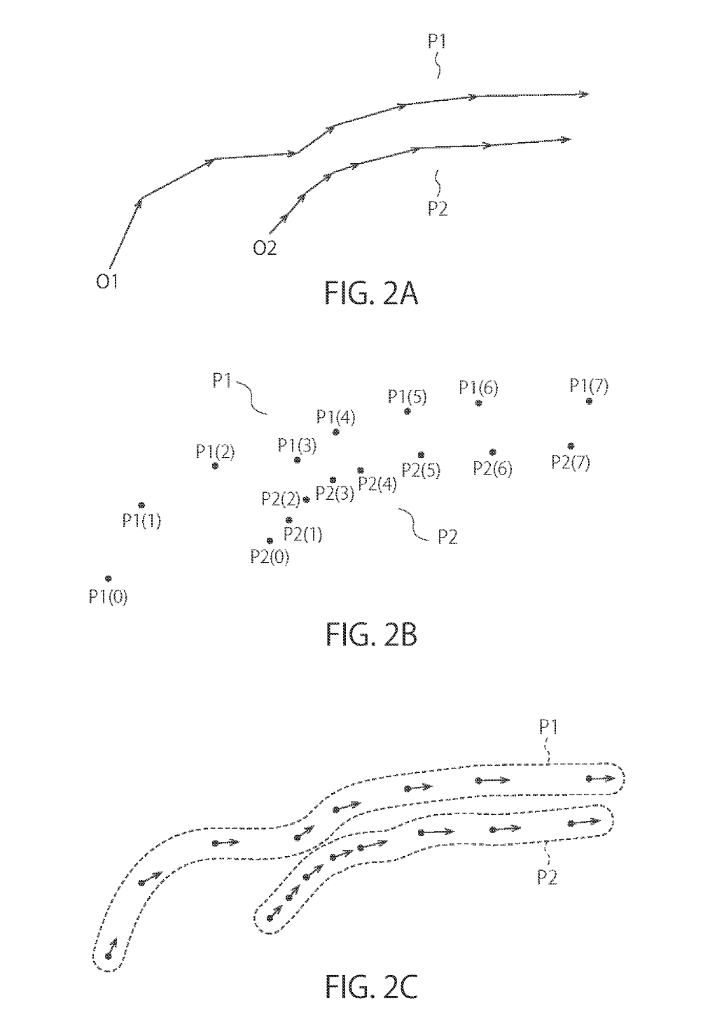

FIG. 2A to FIG. 2C are views each illustrating an example of the path information according to some embodiments. In each of these views, P1 being path information of an object O1 and P2 being path information of an object O2 are illustrated as an example. For example, the path takes a course as illustrated in FIG. 2A.

The path information may be one expressed as, for example, a vector connecting positions at respective times of each object as illustrated in FIG. 2A. By including the position and a movement vector as the path information, the position at each time and the speed at each time of each object can be acquired as the path information.

FIG. 2B is another example of the path information, in which information representing a position of each object at each time is included. For example, referring to FIG. 2B, positions P1(0)-P1(7) denote positions of the object O1, and positions P2(0)-P2(7) denote positions of the object O2. In some embodiments, a movement vector can be calculated from the position of each object at each time. For example, even if the movement vector is not defined, by calculating a vectorial difference between the vectors on a former position and a current position, the movement vector can be obtained. In some embodiments, it is also possible to generate the neural network model in the subsequent second generator 14 as a model which outputs motion information by inputting positional information instead of a movement vector. Such a model can be enabled by performing learning by using, for example, the positional information at the model generation time.

FIG. 2C is still another example of the path information, and including information representing a position and orientation of each object at each time. The orientation of the object at each time may be included as the path information. Similar to the above, it is possible to use the information as the input to the neural network model.

That is, information which is given as the path information may be data including information used for generation of motion information at each time as stated above, and not limited to the position, the orientation, and the like. For example, as a further modification example, not a position at each time but a position at the time “0” (zero) (initial position) and a movement vector after that may be set as the path information, or the initial position and a velocity vector between the time t and the time t+1 may be set as the path information. Further, the information may be combined to be used as the path information. The path information may be output based on parameters such as, for example, a physique. The path information to be output may change depending on, for example, a stride, or the like.

The second generator 14 may generate motion information when each object moves the path information based on the path information of each object generated by the first generator 12. The second generator 14 may generate the motion information according to, for example, a learned neural network model.

The motion information described here is a generic name of data which minutely describe, for example, a motion of an actual object along a path. For example, when the object is a human, a motion or the like of each joint when walking, running, and the like is the motion information. Further, a motion based on parameters added to the path information such as a motion according to gender and age. The motion information may be a motion according to topography such as, for example, a motion going up and down stairs, a motion going up and down the hill, or a motion according to unevenness of the ground.

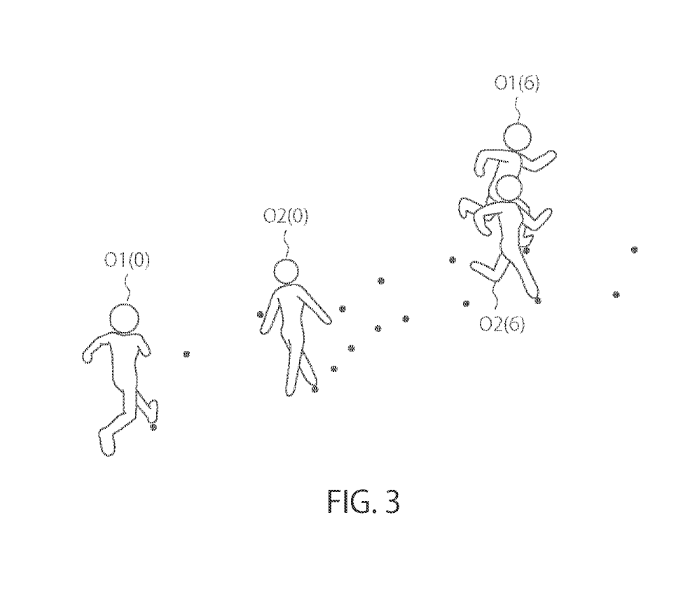

FIG. 3 is a view illustrating an example of motions according to some embodiments. The path information is the same as the one illustrated in FIG. 2A to FIG. 2C. The second generator 14 may output motion information when path information and parameters are input. Each object where motion information is supplied may be output.

For example, it is assumed that the object O1 is a male, and it can be seen from the path information that the object O1 is running at the time “0” (zero). In this case, a running male is output as O1(0), i.e., the state of the object O1 at the time “0” (zero). An object O2 is a female, and it can be seen from the path information that the object O2 is walking at the time “0”. In this case, a walking female is output as O2(0), i.e., the state of the object O2 at the time “0” (zero).

At each time, the motion information (or an object where the motion information is supplied) may be output as stated above. For example, at the time 6, motions where both the object O1 and the object O2 are running may be output as O1(6) and O2(6). In this manner, the motion information at each time (e.g., O1(0)-O1(6), O2(0)-O2(6) in FIG. 3) may be output from the path information.

Further, the second generator 14 may output the motion information at each time based on FPS (frames per second) to be output. For example, motions may be complemented to be output according to discrete information acquired from a learned model so that the object seems to move smoothly by each frame.

The learned neural network model may generate a posture of the next time from a posture of the previous time (for example, a position, rotation, speed, and the like of a joint), information regarding a path (for example, a position, a direction, speed, and the like of a path), and additional information (for example, semantics information such as walking, running). The motion information according to the path information at each time may be output by continuously using the learned model from the start time to the end time of the path information. The learned model may be a model where only the information of path among the path information is input and the motion information is generated and output. As another example, the learned model may be a model where an annotation data such as walking and running is also input together with the information of the path.

Here, a model which is able to output continuous motions such as a model based on a PFNN (phase-functioned neural network) may be used as the neural network model.

Further, a plurality of learned models may be generated based on parameters such as gender, age, and so on, and there may be included a model selector which selects a learned model to be used based on these parameters. For example, learned models which output motion information based on age and gender (a learned model which outputs motion information of a male in his 30's, a learned model which outputs motion information of a female in her 20's, and the like) may be generated, and the model selector may select the learned model to be used depending on the parameters.

When operations of the two generators are summarized, the first generator 12 may generate the path information of a plurality of objects based on, for example, the input parameters as illustrated in FIG. 2A. The second generator 14 may independently generate the motion information regarding each of the path information of the plurality of objects generated by the first generator 12, and sum up (combine) the generated motion information. The second generator 14 may individually infer, for example, the motion information of the object O1 and the motion information of the object O2 illustrated in FIG. 3 by using the learned model, and generate motion information of the plurality of objects (crowd motion) by summing up (combining) the models which are individually output.

The memory 16 may store the models which are used by the second generator 14 for the generation of the motion information. The motion information may be generated and output by the second generator 14 inputting the input data to the learned model stored in the memory 16. The memory 16 may store not only the learned models used by the second generator 14 but also other data (e.g., data input to the learned model) or the like such as programs to control the motion generating apparatus 1.

The video generator 18 may generate and output video images or signals which display the video images based on the information regarding the crowd motion output by the second generator 14. The video images may include still images. That is, the crowd motion including the motion information may be generated and output as video images, or a still image at an arbitrary instant in the crowd motion may be output as one image or a plurality of images. In other words, the video generator 18 may generate and output one or a plurality of images. In some embodiments, the video generator 18 is not included in the motion generating apparatus 1. That is, the motion generating apparatus 1 may generate the motion information, and store or output the motion information. In this case, the motion information may be converted into video images or the like by the video generator 18 which is provided aside from the motion generating apparatus 1. It is thereby possible to output data which is smaller than the data such as images or video images, and is easy to be processed for various uses as the data representing the motion information.

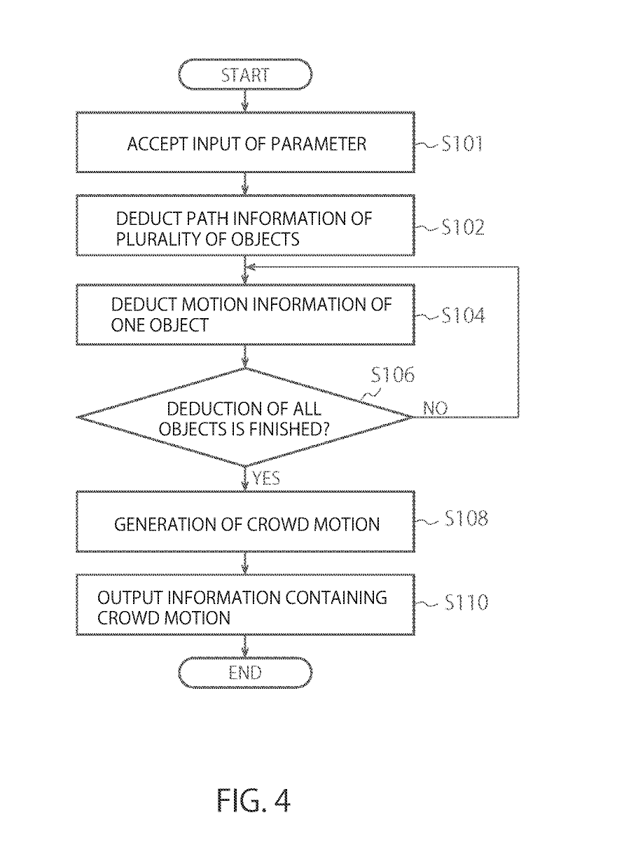

Next, operations of the motion generating apparatus 1 are described by using a flowchart. FIG. 4 is a flowchart illustrating a flow of processing of the motion generating apparatus 1.

First, the parameter input acceptor 10 may accept input of parameters from a user through a user interface (UI) (step S101). The parameters may represent information such as gender, age, a body height, a body weight, and a moving speed of an object, the number of objects, an existing area, and so on. The UI of the parameter input acceptor 10 may be able to determine these parameters.

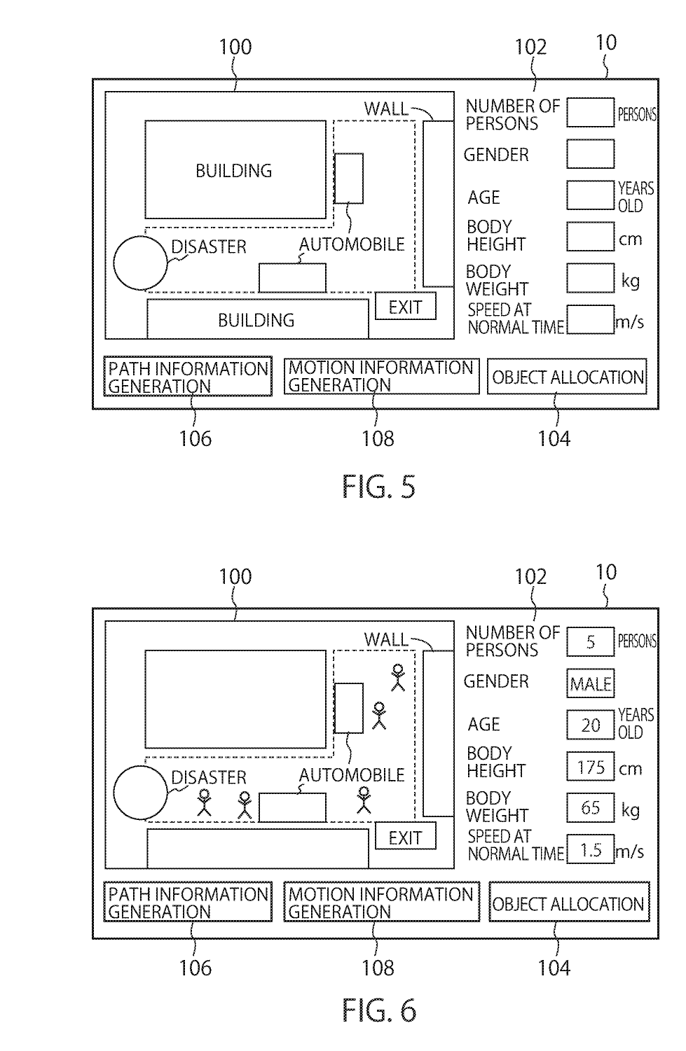

FIG. 5 is a view illustrating an example of a GUI (graphical user interface) of the parameter input acceptor 10. The GUI may include an allocation setting area 100, a parameter setting area 102, an object allocation button 104, and a path information generation button 106 and a motion information generation button 108 which are used in subsequent steps.

The user sets scene information, for example, a position of a place where an object cannot enter such as a position and a height of a building, a position of an automobile, and an area with walls into the allocation setting area 100. The information may be automatically generated based on information which is generated by 3D computer graphics (3DCG) or the like by reading the 3DCG. Next, a range where the object is allocated may be set. For example, an area where the object is allocated may be set as illustrated by a dotted line.

Meanwhile, at the parameter setting area 102, the parameters of the object may be set. For example, items such as the number of persons, gender, age, a body height, a body weight, and a moving speed at a normal time can be set, but settable items are not limited thereto. For example, there may be contained items representing emotion of the object such as a degree of fear, and a degree of panic, and a degree of delight. That is, other parameters may be input as long as the parameters can be used for the crowd motion generation.

The parameters input to the GUI may be transmitted to the motion generating apparatus 1 by, for example, pressing down the object allocation button 104. Each object may be generated or allocated in a range specified in the parameters set in the parameter setting area 102. For example, when the number of objects is specified in the parameter, the specified number of objects are collectively generated and allocated. When the number of objects is not specified, one object may be generated, or the predetermined number of objects which is set in advance may be generated.

An average value and a fluctuation band (or fluctuation range) may be made inputtable regarding each of the parameters which may differ between individuals such as the age, the body height, the body weight, and the speed at the normal time. When the average value and the fluctuation band are input, positive and negative numeric values which are subjected to a random number process based on the fluctuation band may be added to the average value to make it the parameter of each object. The random number process may be performed by giving dependence among respective parameters. For example, the dependence may be given such that when a random number is added to a side where the body weight becomes heavy, a probability that a random number is added to a side where the moving speed becomes late is increased. In this manner, generation of the same object in plural with respect to the input parameters may be suppressed.

It may be set such that when the parameter is changed and the object allocation button 104 is pressed-down, an object can be added so as not to be overlapped with an already allocated object. In some embodiments, an object reallocation button (not shown) may be provided in addition to the object allocation button 104, and when such object reallocation button is pressed-down, an existing object where the parameters are set is canceled, and an object having the parameters set in the parameter setting area 102 may be reallocated. It is thereby possible to widen a range selected by the user regarding an initial value.

Not a single object but objects having any relation may be allocated as the objects. For example, the relation may be flexibly set as a parameter such that there are several sets of couples, several sets of families, and so on.

Examples of other parameters include a moving speed when panicked due to abnormal circumstances, a speed where panic runs down, a speed where a degree of seriousness of the panic proceeds, the relation of objects who have the degree of fear for the panic in common, and the like. An average value and a fluctuation value of each of them may be settable. In addition, a frequency when an object looks around, or the like may be set as a parameter.

Also in the allocation setting area 100, a parameter such as an exit may be set in addition to the above so as to be able to set a direction where an object aims at panic time. An occurrence place and an occurrence time of danger being an origin of the panic may be settable.

The parameter may be input by using GUI, but it is not limited thereto, and for example, a text-based data may be input, or each parameter may be input from a command line.

FIG. 6 is a view illustrating an example where parameters are set in the parameter input acceptor 10, and objects are allocated. When the object allocation button 104 is pressed-down, the objects may be allocated in the allocation setting area 100 based on contents described in the parameter setting area 102.

By using the UI as stated above, the user is able to more easily set the parameters of a plurality of objects than respectively setting the parameters for each object.

Examples of the parameters include the gender, the age, the body height, the body weight, and the moving speed of the object, and the number of objects, the existing range, and the like, but all of them are not required, and at least one parameter may be set. Only one parameter may be used or the parameters may be arbitrarily combined within a range where the first generator 12 can generate. Further, when some parameters among these parameters are input, the first generator 12 may estimate other parameters, set by using a random number, or interpolate with a numeric value or the like set in advance to output the object.

Returning to FIG. 4, the first generator 12 may subsequently generate path information of a generated plurality of objects (step S102). The generation of the path information may be performed by pressing-down the path information generation button 106 in FIG. 5. The first generator 12 may generate paths of the plurality of objects based on rules set in advance.

The path information of each of the plurality of objects at the same timing may be generated such that the objects do not collide with each other. For example, if inferred positions of the same timing of each object indicate the same position (or the same index or the same coordinate), one of the positions may be changed so as to being prevented from indicating the same position. The path information may be generated such that moving information is generated by using a search algorism or the like, and general motions of objects may be added to the moving information based on a rule base.

The moving information may be information such as, for example, a position, an orientation, a speed, and so on of an object at each time. The moving information may be generated by connecting vectors at respective times. The moving information may be generated based on, for example, an A* algorithm, but the algorithm is not limited thereto, and may be generated based on other algorisms such as a Dijkstra's algorithm. The moving information avoiding a collision or the like of the objects with each other may be generated by searching the plurality of objects at the same timing.

General motion information may be added to the moving information through a rule-based method, to generate the path information. The general motion information may be basic information of motions such as walking and running. This information is generated based on a size, an orientation, and the like of a vector of the moving information at each time according to rules defined in advance. For example, when the size of the vector is a predetermined numeric value or less, the motion may be set as a walking motion, and when it exceeds the predetermined value, the motion may be set as a running motion. In some embodiments, general motion information is not added to the moving information, and all motions may be generated at a next step by outputting the vectors of the moving information as the path information.

Next, the second generator 14 may generate motion information of each object based on the path information generated by the first generator 12 according to a learned neural network model (step S104). The motion information may be generated by each object. That is, the path information regarding one object may be extracted from the path information regarding the plurality of objects generated by the first generator 12, and the motion information based on the path information may be generated.

The second generator 14 may acquire, for example, the path information of a certain object generated by the first generator 12, and output the motion information appropriate to the path information based on the path information according to the learned neural network model. This learned model may output the motion information along a path. That is, the second generator 14 may output data where the motion information is added to the path information regarding one object. The output data may be moving image data as it is, or data which is converted into a moving image by being subjected to some processing.

The second generator 14 may generate the motion information also based on data such as the gender and the age which are set as the parameters. This is enabled by using data where motions of persons with various ages, genders, body heights, body weights, and the like are captured as training data when the model is learned. Video images having more natural looks and motions can be generated by inputting the information where the parameters are added. The learned models may be generated based on respective parameters as stated above, and the model selector may select the learned model to be used for the motion generation by the input parameters.

Next, the second generator 14 may determine whether the generation of the motion information with respect to all objects is finished (step S106). When the generation of the motion information with respect to all objects is finished (step S106: YES), the generation of the motion information may be finished. Meanwhile, when the generation of the motion information with respect to all objects is not finished (step S106: NO), the second generator 14 may generate the motion information with respect to the objects whose motion information is not yet generated (step S104).

Step S104 may be an iterative calculation by passing through step S106, but it is not limited thereto. Processing of the plurality of objects may be performed in parallel by using an accelerator such as a GPU including a plurality of arithmetic cores. For example, one arithmetic core of a GPU may perform the arithmetic operation of the motion information generation of one object, so that the arithmetic operations may be performed by the plurality of the arithmetic cores at the same timing with respect to all objects.

Next, the second generator 14 may generate a crowd motion integrating the motion information of all objects which are set based on the motion information of generated each object (step S108).

Next, the video generator 18 may generate and output one or a plurality of images or video images regarding the crowd motion generated by the second generator 14. Further, a background, scene, and so on may be connected, and the images or the video images containing the crowd motion may be generated and output (step S110). The crowd motion may be generated and output as stated above.

As mentioned above, the motion generating apparatus 1 according to some embodiments is able to generate the crowd motion using a neural network model by generating the path information and the motion information in two stages by the first generator 12 and the second generator 14. As stated above, since the parameters of the motion generating apparatus 1 input by the user are very simple, the crowd motion with more natural motions can be generated in low cost.

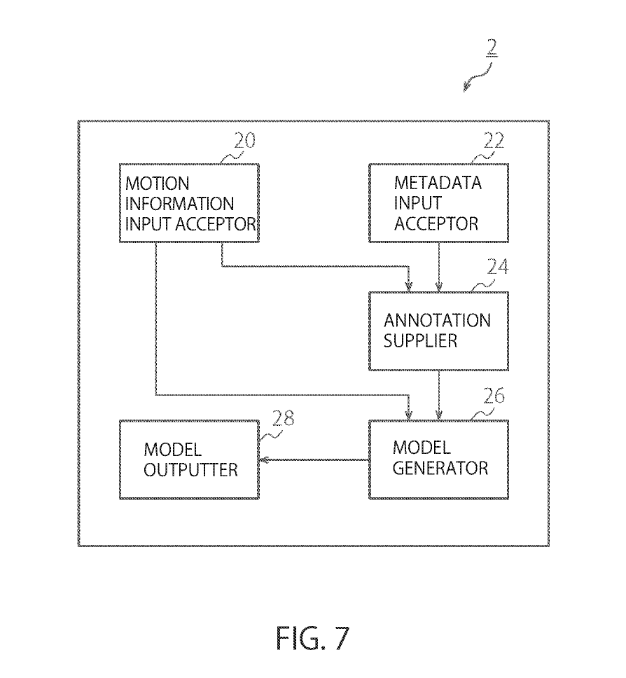

Next, the learning of the neural network model included in the second generator 14 is described. FIG. 7 is a view illustrating an example of a model learning apparatus which learns the neural network model.

A model generating apparatus 2 may include a motion information input acceptor 20, a metadata input acceptor 22, an annotation supplier 24, a model generator 26, and a model outputter 28. The model generating apparatus 2 may generate a neural network model which generates the motion information according to the path information in the above-stated second generator 14.

For example, the model may be one where when metadata (annotation data) regarding the motion information among the path information is input, and the motion information is output. In this case, the second generator 14 may perform a data conversion where the input path information is converted into the metadata. For example, the moving speed is calculated from information of a vector, which is included in the path information, at each time, it is determined whether the motion corresponding to the vector is in a walking state or in a running state, and the result is input to the neural network model as the metadata.

The motion information input acceptor 20 may input data of the motion information to the model generating apparatus 2. The motion information input acceptor 20 may be a motion capture device including a camera or the like, and captured motion information may be input as the data of the motion information. As another example, various captured motion information stored in other file servers or the like may be input through a network or the like.

The data input by the motion information input acceptor 20 may be used as training data in the learning of the model. When the data is used as the training data, a motion information data storage (not shown) may be included in the model generating apparatus 2 in order to speed up access to the training data.

The motion information data may include information on motions, such as a walking motion, a running motion, a motion going up and down a hill, a motion going up and down stairs of a human. The motion information may be used as training data. The motion information may be acquired from a plurality of humans. Otherwise, various motion information may be acquired by capturing motions for a plurality of times with respect to the same motion even if the object is a human.

The motion information data may be acquired with respect to, for example, each gender, age, and so on which can be set as the parameters. For example, information of each of motions such as a walking motion, a running motion, a motion going up and down the hill, and a motion going up and down the stairs of a male in his 30's is acquired. The motion information may be acquired from a plurality of persons with the same parameters. When data according to topography is acquired, the topography data may be generated through CG or the like after the motion information is captured.

The motion information as stated above may be also acquired with respect to, for example, a female in her 20's. The motion information may be acquired with respect to various combinations of parameters, and used as the training data. The motion information including parameters regarding a physique such as a body height and a body weight may be acquired in addition to the gender and the age. A distinction between walking, running, and so on may be modeled by machine learning by inputting a moving speed at a normal time as the parameter.

The motion information with respect to the parameters of the physique may be supplemented by data augmentation, for example, by generating the motion information where the physique is changed by CG or the like.

These data may be learned while being defined not at a pinpoint such as aged 30 and aged 20 but with a certain range such as, for example, in 30's and in 20's. The data may be acquired with respect to various combinations of parameters, the learned model may be generated by each combination, the model selector may be included in the second generator 14 as stated above, and the model selector may select the learned model which generates the motion information based on the input parameters.

As another example, a learned neural network model which outputs the motion information in consideration of the parameters may be generated by inputting the parameters such as gender, age, and physique and metadata. For example, a model may be generated where when other parameters are input by using the neural network model where an input layer in the PFNN is expanded, motion information in consideration of these parameters may be output.

The metadata input acceptor 22 may input metadata together with the motion information to the model generating apparatus 2. When the motion information input acceptor 20 is a motion capture device, the user may immediately input metadata with respect to the captured motion information through the metadata input acceptor 22.

When there is already captured motion information data, it may be input as, for example, text data or binary data. When metadata is added to the already captured motion information data, the added metadata may be input, and in this case, the motion information input acceptor 20 may include a function of the metadata input acceptor 22.

The data which can be input by the parameter input acceptor 10 may be added to the metadata in addition to the information such as walking and running. For example, the data such as gender and age can be contained in the metadata.

The annotation supplier 24 may generate annotation data with respect to the motion information input from the motion information input acceptor 20 from the metadata input through the metadata input acceptor 22. The annotation supplier 24 may function to link between the motion information data and the metadata. In some embodiments, the metadata includes gender or age of the motion actor who made training data, or the actor's name or the like. In some embodiments, the annotation supplier 24 is not included in the model generating apparatus 2 when the metadata is already added to the motion information data as the annotation data. In some embodiments, the annotation data refers to the data used in learning.

The model generator 26 may generate the above-stated neural network model. For example, this neural network model may be modeled by the PFNN, and optimized by the model generator 26 through machine learning. The learning may be executed by using the motion information data and the annotation data. The model generator 26 may generate a model such that the motion information data is output when various information contained in the annotation data is input. The optimization may be performed by using a general machine learning method.

The model outputter 28 may output the neural network model which is generated by the model generator 26. An output destination may be, for example, the second generator 14 of the motion generating apparatus 1.

In some embodiments, at least one or more of the motion information input acceptor 20, the metadata input acceptor 22, the annotation supplier 24, the model generator 26, and the model outputter 28 may be implemented with a circuit (e.g., circuitry of a FPGA, CPU, GPU or other processing circuits implemented using electronic circuits), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like.

As described hereinabove, the model generating apparatus 2 may generate a model which is a learned model used for the generation of the motion information by the second generator 14 and which is stored in the memory 16. The neural network generated by the model generating apparatus 2 may be stored in the memory 16, resulting in that the second generator 14 to which the path information of one object is input generates and outputs the motion information data of the object based on the neural network model.

For example, the path information may be simply the information of a path at each time without containing the parameter information. In this case, the second generator 14 outputs the motion data at a position at each time based on the information such as the position, the orientation, and the speed at each time by the learned model. The position data at each time may be input to the learned model, connected to the motion information at each position, and may be output as motion data at each position. That is, the motion data with natural motion may be output from the learned model while changing the position over time.

As another example, only the motion information data at each time may be output from the learned model, and the second generator 14 may connect the motion information data with the position data at each time to output as the motion data.

As still another example, the path information may contain the parameter information of gender and age. In this case, information of a position at each time, or the like, and information of gender and age of an object may be input to the learned model as the path information. In this case, the learned model may output the motion data containing actions according to the gender, the age, and so on at the position at each time if the training data is acquired so as to contain the parameters in learning.

Further, the path information may contain the parameter information regarding a physique such as a body height, and a body weight. In this case, the information of the physique may be input to the learned model as the path information in addition to the above parameter information. In this case, the learned model is able to output the motion information data containing motions according to the gender and the age, and further to the physique at a position at each time if the training data is acquired so as to contain the parameters in learning.

The learned model is also able to output an appearance according to gender, age, and the like in addition to the path information as the motion information data. For example, it is possible to output an object having an appearance like a female in her 20's when the parameter information of the female in her 20's is input, and an object having an appearance like a male in his 30's when the parameter information of the male in his 30's is input. The learning may be performed such that the appearance is also output together with the motion.

As yet another example, the first generator 12 may generate and output an object model which contains the appearance or the like in some degree based on the parameters such as the gender, the age, and the body height, and based on the moving speed such as walking and running through the rule-based method. In this case, an object model may be input as the path information, and the model generating apparatus 2 is able to output minute motions which are difficult to express through the rule-based method such as, for example, motions of a hand and fingertips, and an angle and expression of a face.

As mentioned above, according to some embodiments, the motion with natural movement can be generated without requiring the user to set minutely regarding individual objects regarding the crowd motion based on the parameters. The motion based on the parameters which are input based on the neural network can be generated, and it is also possible to generate the motion which is difficult to express through the rule-based method or which costs a lot due to a data amount and a process time even if the motion can be expressed.

Meanwhile, the path information may be output through the rule-based method, resulting in that the parameters which were difficult for the user to intervene in the neural network can be input.

That is, according to some embodiments, the parameter setting by the user is enabled by using the rule-based method and the motion data capable of more naturally expressing actions and minute motions can be generated by using the neural network model with less time compared to the case when all arithmetic operations are performed through the rule-based method and the motion data can be output as the crowd motion.

It is difficult to supply variety for the crowd through the motion generation based on only the rule base. In addition, there is a tendency that the number of parameters becomes large to perform minute control, and it causes a large burden on the user. Meanwhile, it is also difficult to generate the path information in consideration of the plurality of objects when the motion generation based on only the neural network is applied to the crowd motion generation. Even when the path information in consideration of the plurality of objects is generated, it is difficult for the neural network to enable user control when the user desires to control the path generation.

As stated above, the following effects can be obtained by dividing the functions into the first generator 12 and the second generator 14. First, problems of supplying the variety for the crowd and enabling the user control based on only the rule base can be solved by introducing the neural network. Second, since the path generation based on the rule is performed by introducing the rule base as a previous stage, a problem of the path generation of the plurality of objects based on only the neural network (e.g., difficulty in user control) can be solved, and further, the problem of enabling the user control can be also solved because a rule-base side is able to cover a part where the user desires to control.

In all of the foregoing explanations, it is described that the first generator 12 generates the path information where collision does not occur, but, in some embodiments, the path information is not necessarily required to be generated so that the collision does not occur. For example, the first generator 12 may include a physical engine. The path information which is not unnatural even when the objects collide with each other may be generated by performing physical simulation by using the physical engine so as not to generate physical mismatch. In this case, the learned neural network provided at the memory may be generated so as to be able to output a collided motion. Such a model can be obtained by using the motion data at the collision time (and the linked path information or metadata) together with the motion data as the training data in learning. Restriction to strictly avoid the collision can be relieved by using the physical engine, and it becomes also possible to generate the colliding motion.

In the motion generating apparatus 1 and the model generating apparatus 2 according to some embodiments, each function may be a circuit constituted by an analog circuit, a digital circuit, or an analog/digital mixed circuit. A control circuit which controls each function may be included. Each circuit may be implemented as an ASIC (application specific integrated circuit), an FPGA (field programmable gate array), and the like.

In all of the foregoing explanations, at least a part of the motion generating apparatus 1 and the model generating apparatus 2 may be constituted by hardware, or by software and CPU or the like may implement the function through information processing of the software. When it is constituted by software, programs which enable the motion generating apparatus 1, the model generating apparatus 2, and at least a part of the functions are stored in storage media such as a flexible disk and a CD-ROM, and may be executed by being read by a computer. The storage media are not limited to detachable media such as a magnetic disk and an optical disk, and may be fixed storage media such as a hard disk device and a memory. That is, the information processing by means of software may be concretely implemented by using hardware resources. The processing by software may be implemented on a circuit such as the FPGA, and may be executed by hardware. The generation of models and the processing after inputting to the model may be performed by using, for example, an accelerator such as a GPU.

For example, a computer can be used as a device according to the embodiment by making the computer read dedicated software stored in a computer-readable storage medium. Kinds of storage media are not particularly limited. The computer can be used as a device according to the embodiment by making the computer install dedicated software which is downloaded through a communication network. The information processing by means of software is thereby concretely implemented by using hardware resources.

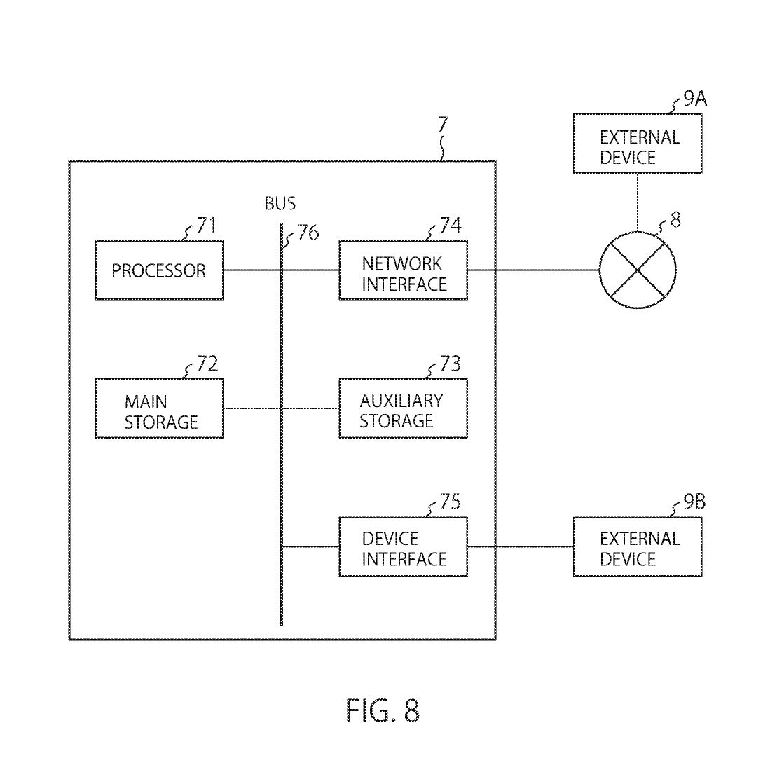

FIG. 8 is a block diagram illustrating an example of a hardware configuration in some embodiments of the present disclosure. The motion generating apparatus 1 or the model generating apparatus 2 may include a processor 71, a main storage 72, an auxiliary storage 73, a network interface 74, and a device interface 75, and they function as a computer device 7 where they are connected through a bus 76.

The computer device 7 in FIG. 8 includes one component each, but a plurality of the same components may be included. In FIG. 8, one computer device 7 is illustrated, but the software may be installed into a plurality of computer devices, and each of the plurality of computer devices may execute a different part of the processing of the software.

The processor 71 is an electronic circuit (processing circuit) including a control device and an arithmetic logic unit of the computer. The processor 71 performs arithmetic processing based on data and programs input from each device or the like of an internal configuration of the computer device 7, and outputs arithmetic operation results and control signals to each device or the like. Concretely, the processor 71 controls each component constituting the computer device 7 by executing OS (operating system), applications, and so on of the computer device 7. The processor 71 is not particularly limited as long as the above-stated processing can be performed. An inspection correspondent, a model correspondent, and each component thereof are enabled by the processor 71.

The main storage 72 is a storage which stores instructions executed by the processor 71, various data, and so on, and information stored in the main storage 72 is directly read by the processor 71. The auxiliary storage 73 is a storage other than the main storage 72. These storages mean arbitrary electronic components capable of storing electronic information, and each may be a memory or a storage. Both a volatile memory and a nonvolatile memory can be used as the memory. The memory to store various data in the motion generating apparatus 1 or the model generating apparatus 2 may be formed by the main storage 72 or the auxiliary storage 73. For example, the memory 16 may be implemented in the main storage 72 or the auxiliary storage 73. As another example, when an accelerator is provided, the memory 16 may be implemented in a memory which is provided at the accelerator.

The network interface 74 is an interface to connect to the communication network 8 through wire or wireless. An interface which is compatible with the existing communication protocol may be used as the network interface 74. The network interface 74 may exchange information with an external device 9A which is communication-connected through the communication network 8.

The external device 9A includes, for example, a camera, a motion capture device, an output destination device, an external sensor, an input source device, and so on. The external device 9A may be a device having a part of functions of the components of the motion generating apparatus 1 and the model generating apparatus 2. The computer device 7 may receive a part of processing results of the motion generating apparatus 1 and the model generating apparatus 2 through the communication network 8 like a cloud service.

The device interface 75 is an interface such as a USB (universal serial bus) which directly connects with an external device 9B. The external device 9B may be an external storage medium or a storage device. The memory 16 may be formed by the external device 9B.

The external device 9B may be an output device. The output device may be, for example, a display device to display images, and a device to output sounds or the like. For example, there are an LCD, (liquid crystal display), a CRT (cathode ray tube), a PDP (plasma display panel), a speaker, and so on, but the output device is not limited thereto.

The external device 9B may be an input device. The input device includes devices such as a keyboard, a mouse, a touch panel, and supplies information input through these devices to the computer device 7. Signals from the input device are output to the processor 71.

While certain embodiments have been described, these embodiments have been presented by way of example only, and are not intended to limit the scope of the present disclosure. Various additions, modifications, and partial deletion may be made within a range not departing from the conceptual idea and the spirit of the present disclosure which are derived from contents stipulated in the accompanying claims and their equivalents. For example, in all of the above-stated embodiments, numeric values used for the explanation are each presented by way of an example, and not limited thereto.

For example, the motion generating apparatus 1 and the model generating apparatus 2 have respectively independent constitutions, but the constitution is not limited thereto, and the model generating apparatus 2 may be included in the motion generating apparatus 1. Otherwise, the motion generating apparatus 1 and the model generating apparatus 2 may be connected through a network or the like, and collaborate to operate.

The model generated by the model generating apparatus 2 according to some embodiments is usable as a program module being a part of artificial-intelligence software. That is, a CPU, a GPU, or the like of a computer operates to perform arithmetic operations based on models stored in a storage and output results.

As stated above, the first generator 12 may include the rule-based AI. The rule-based AI may generate the path information from a position where each object is allocated until a predetermined time. At this timing, an object may be output with an appearance and motion in accordance with parameters or a default appearance and motion together with the path information as an output of the rule-based AI. The path information may contain or may not contain meta information such as walking or running.

The second generator 14 may include a plurality of learned models (for example, PFNN models) which output motion information when the path information generated by the first generator 12 is input. In this case, the second generator 14 may arbitrarily include a model selector which receives parameters and selects a model used for generation of motion information from the plurality of learned models stored in the memory 16 based on the parameters. As another example, a learned model to which parameters can be input (for example, an expanded PFNN model) may be stored in the memory 16. In this case, the model selector is not an essential configuration. When the meta information is contained in the path information, the second generator 14 may input the meta information to the learned model as annotation data. When the meta information is not contained in the path information, the second generator 14 may include an annotation data extractor which extracts the annotation data, and input the extracted annotation data to the learned model.

The configurations of the first generator 12 and the second generator 14 can be appropriately combined.

Various arithmetic operations of learning, deduction may be executed by parallel processing by using, for example, an accelerator such as a GPU or by using a plurality of calculators through a network. For example, batch processing in the learning, processing of generation of motion information of each object or the like in deduction may be executed at the same timing by distributing the arithmetic operations into a plurality of arithmetic cores.

1. A motion generating apparatus comprising:
memory configured to store a learned model, the learned model being configured to output, when path information is input, motion information of an object which moves according to the path information; and
processing circuitry coupled to the memory, the processing circuitry being configured to:
accept input of parameters regarding a plurality of objects;
generate path information of the plurality of objects based on the parameters according to predetermined rules;
input the generated path information of the plurality of objects into the learned model; and
cause the learned model to generate the motion information with respect to the generated path information of the plurality of objects.

2. The motion generating apparatus according to claim 1, wherein
the processing circuitry is further configured to generate one or more images or video images based on the generated path information of the plurality of objects.

3. The motion generating apparatus according to claim 1, wherein
the learned model is a model based on a neural network.

4. The motion generating apparatus according to claim 3, wherein
the learned model is a model based on a phase-functioned neural network (PFNN).

5. The motion generating apparatus according to claim 1, wherein
the memory stores a plurality of learned models based on parameters, and
the processing circuitry is further configured to select a learned model based on the input of parameters among the plurality of learned models stored in the memory.

6. The motion generating apparatus according to claim 1, wherein
when the object is a virtual human, the parameters contain information regarding at least one of gender, age, a body height, a body weight, or a moving speed of the object.

7. The motion generating apparatus according to claim 1, wherein
when the object is a virtual human, the parameters contain information regarding at least one of the number of objects or a range where the object exists.

8. A model generating apparatus comprising:
memory configured to store data; and
processing circuitry coupled to the memory, the processing circuitry being configured to:
input motion information data of an object;
input metadata regarding the motion information data;
generate a neural network model by performing training while using the motion information data and the metadata as training data; and
cause the neural network model to output motion information of moving according to path information when the path information including the metadata is input to the neural network model.

9. The model generating apparatus according to claim 8, wherein
the processing circuitry is further configured to train the neural network model which outputs the motion information based on at least one of a position, a speed, or an acceleration of the object in the path information, or environmental information in the path information.

10. The model generating apparatus according to claim 8, wherein
the neural network model is a model based on a phase-functioned neural network (PFNN).

11. A motion generating method, comprising:
accepting, by processing circuitry coupled to memory, input of parameters regarding a plurality of objects, the memory storing a learned model, the learned model being configured to output, when path information is input, motion information of an object which moves according to the path information;
generating, by the processing circuitry, path information of the plurality of objects based on the parameters according to predetermined rules;
inputting, by the processing circuitry, the generated path information of the plurality of objects to the learned model; and
causing, by the processing circuitry, the learned model to generate the motion information with respect to the generated path information of the plurality of objects.

12. The motion generating method according to claim 11, further comprising:
generating, by the processing circuitry, one or more images or video images based on the generated path information of the plurality of objects.

13. The motion generating method according to claim 11, wherein
the learned model is a model based on a phase-functioned neural network (PFNN).

14. The motion generating method according to claim 11, further comprising:
storing, by the processing circuitry in the memory, a plurality of learned models based on the parameters, and
selecting, by the processing circuitry, the learned model based on the parameters among the plurality of learned models stored in the memory.

15. The motion generating method according to claim 11, wherein
when the object is a virtual human, the parameters contain information regarding at least one of gender, age, a body height, a body weight, or a moving speed of the object, and further contain information regarding at least one of the number of objects or a range where the object exists.
